(19) United States
(12) Patent Application Publication
(10) Pub. No.: US 2011/0274977 A1
(43) Pub. Date: Nov. 10, 2011

(54) POSITIVE ELECTRODE ACTIVE MATERIAL FOR NON-AQUEOUS ELECTROLYTE SECONDARY BATTERY AND METHOD FOR PRODUCING THE SAME

(76) Inventor: Kensuke Nakura, Osaka (JP)

(21) Appl. No.: 13/143,151

(22) PCT Filed: Nov. 11, 2010
(86) PCT No.: PCT/JP2010/006618

§ 371 Date: Jul. 1, 2011

(30) Foreign Application Priority Data
Dec. 1, 2009 (JP) 2009-273783

(51) Int. Cl. H01M 4/52; H01M 4/131

(52) U.S. Cl. 429/223; 252/182.1

(57) ABSTRACT

A method for producing a positive electrode active material for a non-aqueous electrolyte secondary battery includes the steps of: attaching an oxygen permeable ceramic or a precursor thereof to a surface of a nickel-containing oxide or hydroxide to form an intermediate; mixing the intermediate with a lithium compound; and baking the resulting mixture in air to synthesize a lithium nickel composite oxide. The step of attaching the oxygen permeable ceramic or precursor thereof includes, for example, precipitating the oxygen permeable ceramic or precursor thereof on the surface of the oxide or hydroxide in an alkaline aqueous solution.

### TECHNICAL FIELD

This invention relates mainly to an improvement in the method for producing a lithium nickel composite oxide used as a positive electrode active material for a non-aqueous electrolyte secondary battery.

### BACKGROUND ART

Lithium ion secondary batteries such as non-aqueous electrolyte secondary batteries have high electromotive force and high energy density. There is thus an increasing demand for lithium ion secondary batteries as the main power source for mobile communications appliances and portable electronic appliances.

Most of currently commercially available lithium ion secondary batteries include a lithium composite oxide composed mainly of cobalt as a positive electrode active material. However, the raw materials for lithium composite oxides composed mainly of cobalt are costly, thereby leading to intensive studies of lithium composite oxides composed mainly of nickel (lithium nickel composite oxides) (see PTLs 1 to 5).

In addition to reducing raw material costs, it is also important to enhance battery reliability. Lithium nickel composite oxides produce highly-reactive, high-valent Ni⁴⁺ during charge. Accordingly, side reaction related to a lithium nickel composite oxide is promoted in a high-temperature environment. As a result, gas occurs, or it becomes difficult to suppress heat generation upon an internal short-circuit. In order to suppress side reaction, it has been proposed to form a coating film containing one or more specific elements on the surface of a positive electrode active material (see PTLs 6 to 11).

### CITATION LIST

### Patent Literature

[PTL 1] Japanese Laid-Open Patent Publication No. 2006-302880
[PTL 2] Japanese Laid-Open Patent Publication No. 2006-310181
[PTL 3] Japanese Laid-Open Patent Publication No. 2006-351378
[PTL 4] Japanese Laid-Open Patent Publication No. 2006-351379
[PTL 5] Japanese Laid-Open Patent Publication No. 2007-018874
[PTL 6] Japanese Laid-Open Patent Publication No. 2007-018985
[PTL 7] Japanese Laid-Open Patent Publication No. 2007-188878
[PTL 8] Japanese Laid-Open Patent Publication No. 2007-242303
[PTL 9] Japanese Laid-Open Patent Publication No. 2008-077990
[PTL 10] Japanese Laid-Open Patent Publication No. 2008-251480
[PTL 11] Japanese Laid-Open Patent Publication No. 2007-258095

### SUMMARY OF INVENTION

### Technical Problem

A lithium nickel composite oxide is synthesized by mixing a nickel-containing oxide or hydroxide and a lithium compound and baking the resulting raw material mixture in oxygen. Baking the raw material mixture in oxygen, however, has a problem of high process cost. Also, since nickel is more difficult to oxidize than cobalt, baking the raw material mixture in air, which is less costly than oxygen, tends to result in formation of impurities (e.g., a nickel oxide with a rock salt structure).

### Solution to Problem

In view of the above, an object of the invention is to provide a method capable of synthesizing a positive electrode active material including a lithium nickel composite oxide for a non-aqueous electrolyte secondary battery at low costs.

An aspect of the invention relates to a method for producing a positive electrode active material for a non-aqueous electrolyte secondary battery. The method includes the steps of: (i) attaching an oxygen permeable ceramic or a precursor thereof to a surface of a nickel-containing oxide or hydroxide to form an intermediate; (ii) mixing the intermediate with a lithium compound; and (iii) baking the resulting mixture in air to produce a lithium nickel composite oxide.

Another aspect of the invention relates to a positive electrode active material for a non-aqueous electrolyte secondary battery, including a lithium nickel composite oxide and an oxygen permeable ceramic adhering to the composite oxide.

The oxygen permeable ceramic has, for example, a crystal structure of fluorite type, perovskite type, or pyrochlore type.

The crystal structure of the oxygen permeable ceramic can be analyzed by various methods. Examples of analytical methods include XRD (X-ray diffraction) and electron diffraction.

### ADVANTAGEOUS EFFECTS OF INVENTION

In the step of baking the raw material mixture, due to the oxygen permeable ceramic or precursor thereof attached to the surface of the nickel-containing oxide or hydroxide, the oxygen partial pressure increases near the surface of the nickel-containing oxide or hydroxide. Thus, even when the raw material mixture is baked in air, nickel is sufficiently oxidized, and formation of impurities is suppressed.

### BRIEF DESCRIPTION OF DRAWING

FIG. 1 is a longitudinal sectional view of a cylindrical lithium ion secondary battery according to an Example of the invention.

### DESCRIPTION OF EMBODIMENTS

Preferable embodiments of the method for producing a positive electrode active material according to the invention are hereinafter described.

First, a nickel-containing hydroxide is prepared as a raw material for a lithium nickel composite oxide. The nickel-containing hydroxide may contain element L in addition to nickel.

The element L can include at least one selected from the group consisting of alkaline earth elements, transition metal elements other than Ni, rare-earth elements, IIIb group elements, and IVb group elements. Among them, the element L preferably includes at least one selected from the group consisting of Co, Mn, Ti, Al, Mg, Zr, Nb, Y, Ca, In, and Sn, more preferably includes at least one selected from the group consisting of Co, Mn, Al, Ti, Mg, Zr, Nb, and Y, and even more preferably includes at least one of Co and Mn. The inclusion of at least one of Co and Mn can produce the effect of, for example, stabilizing the crystal structure of the composite oxide while suppressing a decrease in capacity.

When the element L includes Co, the atomic ratio “a” of Co to the total of Ni and L is preferably such that 0.05≦a≦0.5, more preferably 0.1≦a≦0.4, and even more preferably 0.1≦a≦0.3.

When the element L includes Mn, the atomic ratio “b” of Mn to the total of Ni and L is preferably such that 0.01≦b≦0.5, more preferably 0.05≦b≦0.4, and even more preferably 0.05≦b≦0.3.

When the element L includes Al, the atomic ratio “c” of Al to the total of Ni and L is preferably such that 0.001≦c≦0.3, and more preferably 0.02≦c≦0.25.

When the element L includes Ti, the atomic ratio “d” of Ti to the total of Ni and L is preferably such that 0.001≦d≦0.3, and more preferably 0.003≦d≦0.2.

However, in terms of obtaining a high capacity, which is an advantage of Ni, the molar ratio of Ni to the total of metal elements contained in the hydroxide is preferably 60 mol % or more, and more preferably 70 mol % or more. Also, in terms of allowing the element L to produce the effect of stabilizing the crystal structure, the molar ratio of Ni to the total of metal elements contained in the hydroxide is preferably 90 mol % or less, and more preferably 85 mol % or less. Accordingly, preferable nickel-containing hydroxides can be represented by, for example, Ni_{1-y}L_{y}(OH)₂ where 0.1≦y≦0.4, and more preferably 0.15≦y≦0.3. More specifically, preferable hydroxides are represented by Ni_{1-y}Co_{y}(OH)₂ and Ni_{1-y}Co_{z}M_{w}(OH)₂ where M is at least one selected from the group consisting of Mn, Al, Ti, Mg, Zr, Nb, and Y, y=z+w, 0.15≦y≦0.27, 0.1≦z≦0.25, and 0.02≦w≦0.1. A preferable example of the latter is Ni_{1-y}Co_{z}Al_{w}(OH)₂.

The method for preparing a hydroxide is not particularly limited. However, in terms of facilitating the synthesis of a lithium nickel composite oxide, the element L is desirably incorporated into the crystal structure of the nickel-containing hydroxide, and a solid solution of nickel and the element L is desirable. Such a solid solution can be synthesized by, for example, coprecipitation. In coprecipitation, it is preferable to precipitate a hydroxide in a reducing atmosphere to prevent an element that is more susceptible to oxidation than Ni from agglomerating.

An example of coprecipitation is a method of preparing an aqueous solution of a raw material salt mixture containing nickel and the element L in a predetermined molar ratio and adding an alkali thereto to obtain a coprecipitated hydroxide. The pH of the aqueous solution is preferably 7 to 14. Also, the water temperature is preferably 10 to 60° C.

A nickel-containing hydroxide may be converted to an oxide. For example, a nickel-containing hydroxide is baked in air to obtain a nickel-containing oxide. An oxide as used herein includes an oxyhydroxide.

(i) First step

An oxygen permeable ceramic or a precursor thereof is attached to the nickel-containing oxide or hydroxide thus prepared. An oxygen permeable ceramic allows oxygen to pass through before allowing nitrogen in the air to pass through, or allows oxygen to pass through without allowing nitrogen to pass through. The preferable range of the oxygen permeation rate is 40 to 60 cm³·cm⁻²·min⁻¹. In this range, in the step of baking the raw material mixture, the oxygen partial pressure near the surface of the nickel-containing oxide or hydroxide can be heightened sufficiently. A precursor of an oxygen permeable ceramic is often a hydroxide containing the same metal elements as those of the oxygen permeable ceramic. The precursor is converted to the oxygen permeable ceramic in the subsequent step of reacting the nickel-containing oxide or hydroxide with a lithium compound.

The oxygen permeation rate of an oxygen permeable ceramic can be measured by the following method.

First, 100 parts by weight of an oxygen permeable ceramic powder with a mean particle size of 10 μm, 10 parts by weight of carboxymethyl cellulose (CMC), and 50 parts by weight of distilled water are stirred with a double-arm kneader to form a paste. This paste is applied onto both faces of a stainless steel mesh with a thickness of 20 μm and an open area ratio of 40% (200 mesh, wire diameter 50 μm, opening 77 μm), which is then dried and rolled to a total thickness of 160 μm to form a green sheet. The green sheet is then baked at 900° C. in air for 12 hours to remove grease and sinter the oxygen permeable ceramic powder to prepare a sintered sheet sample. The porosity of the sample thus obtained is approximately 30%. One end of an alumina cylinder (40 mm ø) is closed with this sample. At this time, using a gold paste, the sample is welded to the inner surface of the alumina cylinder. Thereafter, the alumina cylinder is heated at 750° C., and a mixed gas of He and oxygen (He:oxygen (molar ratio)=80:20) is supplied to the heated alumina cylinder. The pressure of the mixed gas in the alumina cylinder is controlled at 0.2 MPa. The gas having passed through the sample is analyzed by gas chromatography, and the ratio of oxygen to the gas having passed therethrough is calculated.

Various materials having a crystal structure of fluorite type, perovskite type, or pyrochlore type are known as oxygen permeable ceramics. They can be used singly or in combination.

For example, it is preferable to use an oxygen permeable ceramic containing at least one element selected from the group consisting of rare-earth elements, alkali metal elements, and alkaline earth metal elements, since it has high oxygen permeability without adversely affecting battery reaction. Preferable examples of such materials include calcia-doped ceria, magnesia-doped ceria, strontium-doped ceria, calcia-stabilized zirconia, yttria-stabilized zirconia, samarium oxide-stabilized zirconia, gadolinium oxide-stabilized zirconia, La—Sr based oxides (La:Sr (molar ratio)=1:0.5 to 2), Sr—Fe—Co based oxides (Sr:Fe:Co (molar ratio)=1:0.05 to 20:0.05 to 20), and La—Fe—Co based oxides (La:Fe:Co (molar ratio)=1:0.05 to 20:0.05 to 20). Among them, calcia-stabilized zirconia, yttria-stabilized zirconia, and Sr—Fe—Co based oxides are particularly preferable since they have high oxygen permeability.

Stabilized zirconia is a material prepared by incorporating a stabilization element into the crystal structure of zirconia to produce oxygen vacancies, and has a tetragonal or cubic crystal structure. Calcia-stabilized zirconia, yttria-stabilized zirconia, samarium oxide-stabilized zirconia, and gadolinium oxide-stabilized zirconia contain calcium, yttrium, samarium, and gadolinium, respectively, as the stabilization element. The molar ratio of the stabilization element to zirconium is preferably 5 to 50 mol %. Likewise, calcia-doped ceria, magnesia-doped ceria, and strontium-doped ceria contain calcium, magnesium, and strontium, respectively, as the doping element. The molar ratio of the doping element to cerium is preferably 5 to 50 mol %.

The method of attaching an oxygen permeable ceramic or a precursor thereof to a nickel-containing oxide or hydroxide is not particularly limited. For example, simply mixing a nickel-containing oxide or hydroxide and an oxygen permeable ceramic can produce a certain effect. Examples of mixing methods include mechanical alloying and ball milling. In terms of uniformly attaching an oxygen permeable ceramic to the surface of a nickel-containing oxide or hydroxide, the mean particle size A of the oxygen permeable ceramic is preferably 1 to 10 μm. The mean particle size B of the nickel-containing oxide or hydroxide is preferably 2 to 20 times the mean particle size A.

The mean particle size of each material can be measured with, for example, a wet laser particle size distribution analyzer available from Microtrack Inc. In this case, the 50% value (median value: D50) in volume basis particle size distribution can be regarded as the mean particle size of the material.

In terms of attaching an oxygen permeable ceramic to the surface of a nickel-containing oxide or hydroxide more uniformly, it is also possible to use a crystallization method. In a crystallization method, first, an aqueous solution of salts of metal elements (hereinafter “ceramic elements”) serving as the main components of an oxygen permeable ceramic is prepared. A nickel-containing oxide or hydroxide is dispersed in the aqueous solution, and an alkali is further added thereto. As a result, the oxygen permeable ceramic or a precursor thereof is precipitated on the surface of the nickel-containing oxide or hydroxide. A precursor of an oxygen permeable ceramic is often a hydroxide. The precursor is converted to the oxygen permeable ceramic in the step of reacting the nickel-containing oxide or hydroxide with a lithium compound. That is, a precursor as used herein refers to a material which produces an oxygen permeable ceramic when baked in air.

Examples of salts of ceramic elements which can be used include carbonates, sulfates, and nitrates. For example, to produce calcia-doped ceria, magnesia-doped ceria, or strontium-doped ceria, a salt of calcium, magnesium, or strontium and a salt of cerium are used in combination. Also, to produce stabilized zirconia, a salt of a stabilization element and a salt of zirconia are used in combination.

The temperature of the aqueous solution of the salts of ceramic elements is not particularly limited. However, in terms of production costs, it is preferable to control at 20 to 60° C. While the stirring time is not particularly limited, it is, for example, approximately 3 hours. Thereafter, the oxide or hydroxide to which the oxygen permeable ceramic or precursor thereof is attached (intermediate) is collected and dried at a temperature of approximately 80 to 200° C.

The amount of the oxygen permeable ceramic is preferably 0.1 to 10 parts by weight per 100 parts by weight of the nickel-containing oxide or hydroxide, and more preferably 0.5 to 5 parts by weight. By setting the amount of the oxygen permeable ceramic to 0.1 part by weight or more, the oxygen partial pressure near the surface of the nickel-containing oxide or hydroxide can be sufficiently heightened in the step of baking the raw material mixture. Also, by setting the amount of the oxygen permeable ceramic to 10 parts by weight or less, it is possible to suppress the resulting lithium nickel composite oxide from having a large resistance.

### (ii) Second Step

A predetermined amount of a lithium compound is added to the intermediate thus obtained to form a raw material mixture. In the raw material mixture, the molar ratio of Li contained in the lithium compound to the total of Ni and the element L contained in the intermediate, i.e., Li/(Ni+L), is, for example, preferably 0.95 to 1.8, and more preferably 1.0 to 1.5. If Li/(Ni+L) is too small, the crystal of a lithium nickel composite oxide may not grow sufficiently in the step of baking the raw material mixture. If Li/(Ni+L) is too large, excessive lithium may remain as an impurity.

(iii) Third Step

The raw material mixture thus obtained is baked in air to produce a lithium nickel composite oxide. The baking temperature of the raw material mixture is, for example, 600 to 1200° C., and preferably 700 to 1000° C. Also, the oxygen content of the air is 18 to 30 mol %, and preferably 19 to 25 mol %. While the baking time depends on the baking temperature, it is, for example, 3 to 48 hours.

By setting the oxygen content of the air to 18 mol % or more, the reaction between the intermediate and the lithium compound proceeds sufficiently, thereby reducing impurities effectively. Also, by setting the oxygen content of the air to 30 mol % or less, process costs can be reduced effectively.

The oxygen partial pressure of the baking atmosphere is preferably 18 to 30 kPa. If the oxygen partial pressure is too low, the reaction between the precursor and the lithium compound may not proceed sufficiently. If the oxygen partial pressure is too large, the effect of reducing process costs may decrease.

The material obtained after the third step includes the lithium nickel composite oxide and the oxygen permeable ceramic adhering to the composite oxide, and can be used as a positive electrode active material for a non-aqueous electrolyte secondary battery. The oxygen permeable ceramic synthesized by such a method has a crystal structure of fluorite type, perovskite type, or pyrochlore type.

In the positive electrode active material thus obtained, a plurality of primary particles usually agglomerate to form secondary particles. The mean particle size of the primary particles is usually 0.1 to 3 μm, but is not particularly limited thereto. While the mean particle size of the secondary particles is not particularly limited, it is, for example, preferably 1 to 30 μm, and more preferably 10 to 30 μm. The mean particle size can be measured with, for example, a wet laser particle size distribution analyzer available from Microtrack Inc. In this case, the 50% value (median value: D50) in volume basis particle size distribution can be regarded as the mean particle size of the active material particles.

When the nickel-containing hydroxide is Ni_{1-y}L_{y}(OH)₂ where 0.1≦y≦0.4, preferably 0.15≦y≦0.3, a lithium nickel composite oxide having the composition of LiₓNi_{1-y}L_{y}O₂ where 0.1≦y≦0.4, preferably 0.15≦y≦0.3 can be obtained. The range of x representing the Li content decreases/increases due to charge/discharge of the battery. The range of x in a fully discharged state (initial state) is preferably such that 0.85≦x≦1.25, and more preferably 0.93≦x≦1.1. Likewise, when the nickel-containing hydroxide is Ni_{1-y}Co_{y}(OH)₂, Ni_{1-y}Co_{z}M_{w}(OH)₂, or Ni_{1-y}Co_{z}Al_{w}(OH)₂, a lithium nickel composite oxide having the composition of LiₓNi_{1-y}Co_{y}O₂, LiNi_{1-y}Co_{z}M_{w}O₂, or LiNi_{1-y}Co_{z}Al_{w}O₂ can be obtained.

It should be noted that an element of the oxygen permeable ceramic may diffuse into the lithium nickel composite oxide, thereby making the concentration of the element L in the lithium nickel composite oxide near the surface portion higher than that inside the active material particle. That is, an element of the oxygen permeable ceramic may change to the element L of the lithium nickel composite oxide. However, the amount of element which diffuses into the lithium nickel composite oxide from the oxygen permeable ceramic is slight and negligible. Even when it is ignored, the effects of the invention are hardly affected.

In the case of an active material in which primary particles agglomerate to form secondary particles, the oxygen permeable ceramic may be present only on the surfaces of the primary particles, may be present only on the surfaces of the secondary particles, or may be present on the surfaces of both primary and secondary particles.

The method for producing a positive electrode using the positive electrode active material thus produced is not particularly limited. Generally, a positive electrode mixture including active material particles and a binder is disposed on a strip-shaped positive electrode substrate (positive electrode current collector). The positive electrode mixture can further contain additives such as a conductive agent as optional components. The positive electrode mixture is dispersed in a liquid component to form a paste, and the paste is applied onto a substrate and dried, whereby the positive electrode mixture can be disposed on the substrate. The positive electrode mixture disposed on the positive electrode substrate is then rolled with rollers.

Examples of the binder contained in the positive electrode mixture include polyethylene, polypropylene, polytetrafluoroethylene (PTFE), polyvinylidene fluoride (PVDF), styrene butadiene rubber, and tetrafluoroethylene-hexafluoropropylene copolymer (FEP). They can be used singly or in combination.

Examples of the conductive agent contained in the positive electrode mixture include graphite, carbon black, carbon fibers, and metal fibers. They can be used singly or in combination.

The positive electrode substrate (positive electrode current collector) can be a foil or sheet made of aluminum, stainless steel, nickel, titanium, carbon, a conductive resin, or the like. While the thickness of the positive electrode substrate is not particularly limited, it is, for example, in the range of 5 to 50 μm.

The non-aqueous electrolyte secondary battery includes the above-described positive electrode, a chargeable/dischargeable negative electrode, a non-aqueous electrolyte, and a separator.

The negative electrode can comprise, for example, a negative electrode mixture being disposed on a negative electrode substrate and including a negative electrode active material, a binder, and optional components such as a conductive agent or a thickener. Such a negative electrode can be produced by, for example, a method similar to that for producing the positive electrode.

The negative electrode active material can be lithium metal or any material capable of electrochemically absorbing and desorbing lithium. For example, graphites, non-graphitizable carbon materials, lithium alloys, and metal oxides can be used. Preferable lithium alloys include at least one selected from the group consisting of silicon, tin, aluminum, zinc, and magnesium. Preferable metal oxides are oxides containing silicon and oxides containing tin, and composites of such a metal oxide and a carbon material are more preferable. While the mean particle size of the negative electrode active material is not particularly limited, it is preferably 1 to 30 μm.

The binder and conductive agent contained in the negative electrode mixture can be, for example, the same materials as those which can be contained in the positive electrode mixture.

The negative electrode substrate (negative electrode current collector) can be a foil or sheet made of stainless steel, nickel, copper, titanium, carbon, conductive resin, or the like. While the thickness of the negative electrode substrate is not particularly limited, it is, for example, in the range of 5 to 50 μm.

The non-aqueous electrolyte preferably comprises a non-aqueous solvent and a lithium salt dissolved therein. Preferable examples of non-aqueous solvents which can be used are cyclic carbonates such as ethylene carbonate (EC), propylene carbonate (PC), and butylene carbonate (BC). Examples of lithium salts which can be used include LiClO₄, LiBF₄, and LiPF₆. The concentration of the lithium salt is preferably 0.5 to 1.5 mol/L.

A separator needs to be disposed between the positive electrode and the negative electrode. The separator is preferably an insulating microporous thin film having high ion permeability and a predetermined mechanical strength. The microporous thin film preferably has the function (shut-down function) of closing pores at a certain temperature or higher to increase resistance. The material of the microporous thin film is preferably a polyolefin such as polypropylene or polyethylene. The thickness of the separator is approximately 10 to 300 μm.

The invention is hereinafter described more specifically by way of Examples.

### Example 1

### (i) Synthesis of Nickel-Containing Hydroxide

A raw material solution was prepared by dissolving 3.2 kg of a mixture of nickel sulfate and cobalt sulfate in a molar ratio of Ni atoms to Co atoms of 80:20 in 10 L of water. To the raw material solution was added 400 g of sodium hydroxide to form a precipitate. The precipitate was sufficiently washed with water and dried to obtain a coprecipitated hydroxide.

### (ii) Addition of Oxygen Permeable Ceramic

Calcium sulfate and zirconium sulfate were dissolved in ion-exchange water in a molar ratio of 3:17 to form a solution. In 3 L of this solution was dispersed 3 kg of the coprecipitated hydroxide (Ni_{0.8}Co_{0.2}(OH)₂). The resulting dispersion was stirred at 25° C. for 3 hours, dehydrated, and dried at 100° C. for 2 hours to obtain an intermediate of a composite oxide. The amount of oxygen permeable ceramic precursor added, determined from the rate of weight increase, was 0.5 part by weight per 100 parts by weight of the coprecipitated hydroxide. An ICP analysis showed that the precursor contained 7.75 parts by weight of calcium per 100 parts by weight of zirconium.

### (iii) Baking of Raw Material Mixture

A predetermined amount of lithium carbonate was added to 3 kg of the intermediate thus obtained, which was then baked at a temperature of 750° C. in air (an oxygen content of 21 mol % and an oxygen partial pressure of 20 kPa) for 12 hours. As a result, a positive electrode active material (mean particle size 12 μm) comprising a lithium nickel composite oxide (LiNi_{0.8}Co_{0.2}O₂) and an oxygen permeable ceramic adhering to the surface thereof was obtained.

The surface of the positive electrode active material was analyzed by XRD and electron diffraction, which confirmed that an oxygen permeable ceramic having a fluorite type structure and a composition of Ca_{0.15}Zr_{0.85}O_{1.85} (calcia-stabilized zirconia) was adhering thereto. Separately, the oxygen permeation rate of Ca_{0.15}Zr_{0.85}O_{1.85} was measured and found to be 40 cm³·cm⁻²·min⁻¹.

### (iv) Production of Positive Electrode

A positive electrode mixture paste was prepared by stirring 1 kg of the positive electrode active material thus obtained, 0.5 kg of PVDF #1320 of Kureha Corporation (N-methyl-2-pyrrolidone (NMP) solution with a solid content of 12% by weight), 40 g of acetylene black, and a suitable amount of NMP with a double-arm kneader. This paste was applied onto both faces of a 20-μm thick aluminum foil, which was then dried and rolled so that the total thickness was 160 μm. Thereafter, the resulting electrode plate was slit to such a width that it was capable of being inserted into a cylindrical 18650 battery case, to produce a positive electrode.

### (v) Production of Negative Electrode

A negative electrode mixture paste was prepared by stirring 3 kg of artificial graphite, 200 g of BM-400B of Zeon Corporation (dispersion of modified styrene-butadiene rubber with a solid content 40% by weight), 50 g of carboxymethyl cellulose (CMC), and a suitable amount of water with a double-arm kneader. This paste was applied onto both faces of a 12 μm-thick copper foil, which was then dried and rolled so that the total thickness was 160 μm. Thereafter, the resulting electrode plate was slit to such a width that it was capable of being inserted into a cylindrical 18650 battery case, to produce a negative electrode.

### (vi) Fabrication of Battery

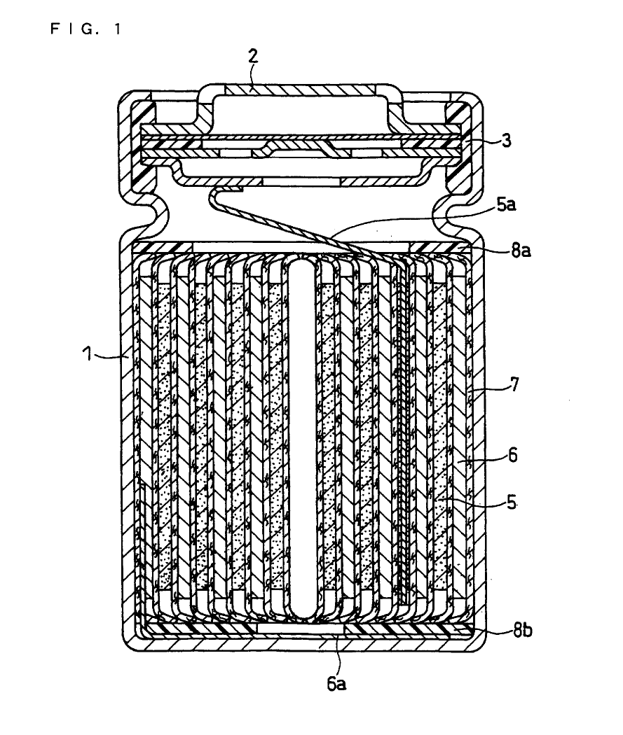

As illustrated in FIG. 1, a positive electrode 5, a negative electrode 6, and a separator 7 interposed therebetween were wound to form a spirally wound electrode assembly. The separator 7 was a composite film of polyethylene and polypropylene (2300 of Celgard K. K., thickness 25 μm). A nickel positive electrode lead 5a and a nickel negative electrode lead 6a were attached to the positive electrode 5 and the negative electrode 6, respectively. The resulting electrode assembly with an upper insulator plate 8a and a lower insulator plate 8b mounted on the upper and lower faces, respectively, was inserted in a battery case 1, and 5 g of a non-aqueous electrolyte was injected in the battery case 1. The solvent of the non-aqueous electrolyte was a solvent mixture of ethylene carbonate and methyl ethyl carbonate in a volume ratio of 10:30. To the solvent mixture were added 2% by weight of vinylene carbonate, 2% by weight of vinyl ethylene carbonate, 5% by weight of flouorobenzene, and 5% by weight of phosphazene. In the resulting liquid mixture was dissolved LiPF₆ at a concentration of 1.5 mol/L. In this manner, a non-aqueous electrolyte was produced. Thereafter, a seal plate 2 around which an insulating gasket 3 was fitted was electrically connected to the positive electrode lead 5a, and the opening of the battery case 1 was sealed with the seal plate 2. In this manner, a cylindrical 18650 lithium secondary battery was completed.

### Comparative Example 1

A battery was produced in the same manner as in Example 1, except that in the synthesis of a positive electrode active material, no oxygen permeable ceramic was added to the nickel-containing hydroxide (Ni_{0.8}Co_{0.2}(OH)₂).

### [Evaluation]

### (Discharge Characteristic)

Each battery was preliminarily subjected to two charge/discharge cycles and stored in an environment of 40° C. for 2 days. Each battery was then subjected to the following cycle test. The design capacity of the batteries was set to 1 CmAh. The ratio of the discharge capacity at the 500^{th} cycle to the discharge capacity at the 1^{st} cycle is shown as capacity retention rate in Table 1.

(1) Constant current charge (45° C.): 0.7 CmA (cut-off voltage 4.2 V)

(2) Constant voltage charge (45° C.): 4.2 V (cut-off current 0.05 CmA)

(3) Charge rest (45° C.): 30 minutes

(4) Constant current discharge (45° C.): 1 CmA (cut-off voltage 3 V)

(5) Discharge rest (45° C.): 30 minutes

TABLE 1

| | Capacity retention rate |
|---|---|
| | (%) |
| Example 1 | 70 |
| Comparative Example 1 | 40 |

Table 1 shows that the battery of Example 1 has a good cycle characteristic compared with Comparative Example 1. The reason is probably as follows. The positive electrode active material of Example 1 contains almost no impurities (in particular, nickel oxides with a rock salt structure), thereby suppressing side reaction between the non-aqueous electrolyte and impurities. On the other hand, the positive electrode active material of Comparative Example 1 contains relatively large amounts of impurities, thereby causing side reaction and resulting in a poor cycle characteristic.

### Example 2

In the step of synthesizing a hydroxide, the molar ratio of Ni atoms to Co atoms was set to 60:40 to synthesize Ni_{0.6}Co_{0.4}(OH)₂. Using this, a battery was produced in the same manner as in Example 1, and the capacity retention rate was obtained in the same manner. The capacity retention rate was 75%.

### Example 3

In the step of synthesizing a hydroxide, the molar ratio of Ni atoms to Co atoms was set to 50:50 to synthesize Ni_{0.5}Co_{0.5}(OH)₂. Using this, a battery was produced in the same manner as in Example 1, and the capacity retention rate was obtained in the same manner. The capacity retention rate was 60%.

Examples 2 and 3 have confirmed that when the molar ratio of Ni to the total of metal elements contained in a hydroxide is 60% or more, the invention is significantly effective.

### Example 4

Batteries were produced in the same manner as in Example 1, except that an oxygen permeable ceramic was mixed with Ni_{0.8}Co_{0.2}(OH)₂ (hydroxide) not by crystallization but by ball milling. In the ball milling, YSZ balls of Nikkato Corporation were used. Specifically, 2 L of zirconia balls with a diameter of 5 mm were placed in a reaction chamber with a volume of 5 L, and 2000 g of Ni_{0.8}Co_{0.2}(OH)₂ (hydroxide) and 100 g of an oxygen permeable ceramic were further placed therein. They were mixed at 100 rpm for 3 hours.

The following materials were used as oxygen permeable ceramics.

TABLE 2

| | | Mean | Oxygen | Capacity |
|---|---|---|---|---|
| | | particle | permeation rate | retention |
| Oxygen permeable ceramics | Crystal structure | size | (cm³ · cm⁻² · min⁻¹) | rate (%) |
| Calcia-doped ceria | Fluorite type | 10 μm | 40 | 80 |
| Ca:Ce(molar ratio) = 10:90 | | | | |
| Magnesia-doped ceria | Fluorite type | 8 μm | 50 | 70 |
| Mg:Ce(molar ratio) = 10:90 | | | | |
| Strontium-doped ceria | Fluorite type | 6 μm | 45 | 75 |
| Sr:Ce(molar ratio) = 20:80 | | | | |
| Calcia-stabilized zirconia | Fluorite type | 10 μm | 40 | 80 |
| Ca:Zr(molar ratio) = 10:90 | | | | |
| Yttria-stabilized zirconia | Fluorite type | 5 μm | 50 | 75 |
| Y:Zr(molar ratio ) = 10:90 | | | | |
| Samarium oxide-stabilized | Pyrochlore type | 6 μm | 50 | 70 |
| zirconia | | | | |
| Sm:Zr(molar ratio) = 10:90 | | | | |
| Gadolinium oxide-stabilized | Fluorite type | 7 μm | 45 | 80 |
| zirconia | | | | |
| Gd:Zr(molar ratio) = 10:90 | | | | |
| Sr—Fe—Co based oxide | Perovskite type | 4 μm | 40 | 70 |
| Sr:Fe:Co(molar ratio) = 10:3:7 | | | | |
| La—Fe—Co based oxide | Perovskite type | 4 μm | 40 | 85 |
| La:Fe:Co(molar ratio) = 10:2:8 | | | | |
| La—Sr based oxide | Perovskite type | 4 μm | 45 | 75 |
| La:Sr(molar ratio) = 6:4 | | | | |

Using the intermediates thus prepared, batteries were produced in the same manner as in Example 1, and their capacity retention rates were obtained. Table 2 shows the results.

Table 2 indicates that the use of the intermediates including oxygen permeable ceramics with oxygen permeation rates of 40 to 60 cm³·cm⁻²·min⁻¹ can provide high capacity retention rates, compared with Comparative Example 1. Therefore, the positive electrode active materials of this example are thought to contain almost no impurities.

### Example 5

### (i) Synthesis of Nickel-Containing Hydroxide

A raw material solution was prepared by dissolving 3.2 kg of a mixture of nickel sulfate and cobalt sulfate in a molar ratio of Ni atoms to Co atoms to Al atoms of 80:15 in 10 L of water. To the raw material solution was added 400 g of sodium hydroxide to form a precipitate. The precipitate was sufficiently washed with water and dried to obtain a coprecipitated hydroxide.

A dispersion of the coprecipitated hydroxide (Ni_{0.842}Co_{0.158}(OH)₂) in NMP was introduced into a planetary ball mill together with zirconia beads with a diameter of 2 mm and pulverized. Due to the pulverization step, the mean particle size of the coprecipitated hydroxide was reduced to 2 μm. Subsequently, while the pulverized coprecipitated hydroxide was being stirred in water, an aluminum sulfate aqueous solution (concentration 1 mol/L) and a sodium hydroxide aqueous solution (concentration 1 mol/L) were dropped so that the molar ratio of the total of nickel and cobalt to aluminum was 95:5 to form a composite hydroxide (Ni_{0.8}Co_{0.15}Al_{0.05}(OH)₂) with aluminum hydroxide added. Using the composite hydroxide thus obtained, a positive electrode active material was synthesized in the same manner as in Example 1.

After the addition of an oxygen permeable ceramic (preparation of an intermediate) and baking of a raw material mixture, the resulting positive electrode active material had a mean particle size of 13 μm. Using this positive electrode active material, a battery was produced in the same manner as in Example 1, and the capacity retention rate was obtained in the same manner. Table 3 shows the result.

TABLE 3

| | Capacity retention rate |
|---|---|
| | (%) |
| Example 5 | 75 |
| Comparative Example 2 | 50 |

### Example 6

An oxygen permeable ceramic was mixed with Ni_{0.8}Co_{0.15}Al_{0.05}(OH)₂ (hydroxide) not by crystallization but by ball milling in the same manner as in Example 5. In the same manner as in Example 1, batteries were produced, and their capacity retention rates were obtained. Table 4 shows the results and the oxygen permeable ceramics used.

TABLE 4

| | | Mean | Oxygen | Capacity |
|---|---|---|---|---|
| | | particle | permeation rate | retention |
| Oxygen permeable ceramics | Crystal structure | size | (cm³ · cm⁻² · min⁻¹) | rate (%) |
| Calcia-doped ceria | Fluorite type | 10 μm | 40 | 80 |
| Ca:Ce(molar ratio) = 10:90 | | | | |
| Magnesia-doped ceria | Fluorite type | 8 μm | 50 | 75 |
| Mg:Ce(molar ratio) = 10:90 | | | | |
| Strontium-doped ceria | Fluorite type | 6 μm | 45 | 80 |
| Sr:Ce(molar ratio) = 20:80 | | | | |
| Calcia-stabilized zirconia | Fluorite type | 10 μm | 40 | 85 |
| Ca:Zr(molar ratio) = 10:90 | | | | |
| Yttria-stabilized zirconia | Fluorite type | 5 μm | 50 | 75 |
| Y:Zr(molar ratio ) = 10:90 | | | | |
| Samarium oxide-stabilized | Pyrochlore type | 6 μm | 50 | 75 |
| zirconia | | | | |
| Sm:Zr(molar ratio) = 10:90 | | | | |
| Gadolinium oxide-stabilized | Fluorite type | 7 μm | 45 | 80 |
| zirconia | | | | |
| Gd:Zr(molar ratio) = 10:90 | | | | |
| Sr—Fe—Co based oxide | Perovskite type | 4 μm | 40 | 75 |
| Sr:Fe:Co(molar ratio) = 10:3:7 | | | | |
| La—Fe—Co based oxide | Perovskite type | 4 μm | 40 | 85 |
| La:Fe:Co(molar ratio) = 10:2:8 | | | | |
| La—Sr based oxide | Perovskite type | 4 μm | 45 | 80 |
| La:Sr(molar ratio) = 6:4 | | | | |

Table 4 indicates that the use of the intermediates including oxygen permeable ceramics with oxygen permeation rates of 40 to 60 cm³·cm⁻²·min⁻¹ can provide high capacity retention rates, compared with Comparative Example 2. Therefore, the positive electrode active materials of this example are thought to contain almost no impurities.

### INDUSTRIAL APPLICABILITY

The invention is applicable to positive electrodes for various non-aqueous electrolyte secondary batteries. The use of the positive electrode active materials produced by the invention can provide non-aqueous electrolyte secondary batteries that are suitable as the power sources for personal digital assistants, portable electronic appliances, small power storage devices for houses, two-wheel motor vehicles, electric vehicles, hybrid electric vehicles, etc.

### REFERENCE SIGNS LIST

1 Battery Case
2 Seal Plate
3 Insulating Gasket
5 Positive Electrode
5a Positive Electrode Lead
6 Negative Electrode
6a Negative Electrode Lead
7 Separator
8a Upper Insulator Plate
8b Lower Insulator Plate

1. A method for producing a positive electrode active material for a non-aqueous electrolyte secondary battery, the method comprising the steps of:
(i) attaching an oxygen permeable ceramic or a precursor thereof to a surface of a nickel-containing oxide or hydroxide to form an intermediate;
(ii) mixing the intermediate with a lithium compound; and
(iii) baking the resulting mixture in air to produce a lithium nickel composite oxide.

2. The method for producing a positive electrode active material for a non-aqueous electrolyte secondary battery in accordance with claim 1, wherein the step of attaching the oxygen permeable ceramic or precursor thereof includes precipitating the oxygen permeable ceramic or precursor thereof on the surface of the oxide or hydroxide in an alkaline aqueous solution.

3. The method for producing a positive electrode active material for a non-aqueous electrolyte secondary battery in accordance with claim wherein the oxygen permeable ceramic has a crystal structure of fluorite type, perovskite type, or pyrochlore type.

4. The method for producing a positive electrode active material for a non-aqueous electrolyte secondary battery in accordance with claim 3, wherein the oxygen permeable ceramic includes at least one element selected from the group consisting of rare-earth elements, alkali metal elements, and alkaline earth metal elements.

5. The method for producing a positive electrode active material for a non-aqueous electrolyte secondary battery in accordance with claim 4, wherein the oxygen permeable ceramic comprises at least one selected from the group consisting of calcia-doped ceria, magnesia-doped ceria, strontium-doped ceria, calcia-stabilized zirconia, yttria-stabilized zirconia, strontium-stabilized zirconia, samarium oxide-stabilized zirconia, gadolinium oxide-stabilized zirconia, La—Sr based oxides, Sr—Fe—Co based oxides, and La—Fe—Co based oxides.

6. The method for producing a positive electrode active material for a non-aqueous electrolyte secondary battery in accordance with claim 1, wherein the molar ratio of Ni to the total of metal elements contained in the oxide or hydroxide is 60 mol % or more.

7. The method for producing a positive electrode active material for a non-aqueous electrolyte secondary battery in accordance with claim 1, wherein the amount of the oxygen permeable ceramic or precursor thereof is 0.1 to 10 parts by weight per 100 parts by weight of the oxide or hydroxide.

8. The method for producing a positive electrode active material for a non-aqueous electrolyte secondary battery in accordance with claim 1, wherein the air has an oxygen content of 18 to 30 mol %.

9. The method for producing a positive electrode active material for a non-aqueous electrolyte secondary battery in accordance with claim 1, wherein the oxygen permeable ceramic has an oxygen permeation rate of 40 to 60 cm³·cm-2·min-1.

10. A positive electrode active material for a non-aqueous electrolyte secondary battery, comprising a lithium nickel composite oxide and an oxygen permeable ceramic adhering to the composite oxide.

11. The positive electrode active material for a non-aqueous electrolyte secondary battery in accordance with claim 10, wherein the oxygen permeable ceramic has a crystal structure of fluorite type, perovskite type, or pyrochlore type.

12. The positive electrode active material for a non-aqueous electrolyte secondary battery in accordance with claim 10, wherein the oxygen permeable ceramic has an oxygen permeation rate of 40 to 60 cm3·cm-2·min-1.

13. A positive electrode active material for a non-aqueous electrolyte secondary battery, which is prepared by the production method of claim 1.
